(19) United States
(12) Patent Application Publication
(10) Pub. No.: US 2006/0178898 A1
(43) Pub. Date: Aug. 10, 2006

(54) Unified event monitoring system

(76) Inventor: Babak "Bobi" Habibi, Vienna, VA (US)

Correspondence Address: STEVENS DAVIS MILLER & MOSHER, LLP, 1615 L STREET, NW, SUITE 850, WASHINGTON, DC, 20036, US

(21) Appl. No.: 11/186,782

(22) Filed: Jul. 22, 2005

Related U.S. Application Data
(60) Provisional application No. 60/650,133, filed on Feb. 7, 2005.

(51) Int. Cl. G06Q 99/00; G06Q 30/00

(52) U.S. Cl. 705/1; 705/26

(57) ABSTRACT

The present invention provides a system that integrates requests and responses thereto for Operation and Business Support Systems (OSS/BSS) that comprise many discrete and non-inclusive systems with disparate interfaces. The integration of these systems poses a complex problem. Moreover, costs of licenses, maintenance fees, and training for day-to-day use are prohibitively expensive. The present invention is an open and inclusive system that interfaces easily with existing OSS/BSS systems to provide visibility into all network elements and events. It is an advanced, multi-vendor management system designed to increase efficiency and productivity and reduce network administration costs by providing an integrated system for monitoring, troubleshooting, and managing the network. The present invention has as an objective to unite different systems under one common platform. The present invention collects and manipulates information centrally, within a single system, enabling critical data to be shared seamlessly between applications. This provides for Data Consolidation, Data Extendibility, and Reduced Cost. In addition, this solution is robust, as it is expandable and considerate of new systems and technologies as they emerge.

### REFERENCE TO RELATED APPLICATION

The present invention claims priority to U.S. provisional application No. 60/650,133 filed on Feb. 7, 2005, the entire text of which is hereby incorporated by reference.

### BACKGROUND OF THE INVENTION

Large organizations, such as government agencies, telecommunications companies, and the like, collect vast amounts of data concerning their telecommunications, information technology, building control, and other systems. Unfortunately, this data is most often accessible only through custom software applications developed by the developer of the particular IT, building control on telecommunication system. Each such software application uses its own fault and performance management system, and these systems typically have disparate interfaces.

One such application is Webview, which is designed and developed to “web enable” NetCool Object Server. This product uses Java and JDBC technologies to allow for scalability. Webview also offers a topology view, along with messages and alerts. However, the product gets its information directly from the Object Servers and lacks the ability to accept manipulate and display input from other sources. Access to functionality provided by this product is also limited based on what the vendor allows, since Webview does not have a universal access method to the message domain. In addition, with NetCool version 4.0, there are issues regarding the interface of NetCool and Webview products. With NetCool 4.0, Webview has to revise its approach to accessing data.

Another common application is NetCool Wave, and its JEL component. The JEL component substantially increases the cost of NetCool Wave (“Wave”). Furthermore, unlike Webview, which provides mapping and event lists in a single system, Wave only provides mapping. Wave has a similar functionality to, and shares many of the same shortcomings with, Webview. NetCool Wave and the JEL component all closed solutions that tend to be costly.

Available Solution Summary Matrix

TABLE 1

| SOLUTION | FUNCTIONALITY | FLEXIBILITY |
|---|---|---|
| Web View | NetCool Data Only | Medium |
| | Limited Access to Data Offers Network | |
| | Diagrams | |
| | Scalable | |
| Wave & JEL | NetCool Data Only | Medium |
| (NetCool) | Limited Access to Data | |
| | Scalable | |

Table 1 provides additional functionality, flexibility, and cost information on the current solutions available.

Clearly, these systems prove to be costly, especially when licensing and employee training are taken into account.

Because all of the currently available systems are proprietary closed systems, employees have to learn and use different applications to manage similar information. This makes it both expensive and difficult to effectively and efficiently train, and cross-train, employees.

### SUMMARY OF THE INVENTION

Accordingly, the present invention is directed to a unified event monitoring system that substantially obviates one or more of the problems due to limitations and disadvantages of the related art.

Referring now to FIGS. 1A-1 and 1A-2, an architecture and schematic is provided, respectively, of a first embodiment of the present invention which is used for tracking orders, especially telecommunications service and provisioning orders.

In today's world, enterprises and organizations require totally reliable telecommunications services. Most organizations maintain Service Level Agreements (SLAs) with Telecommunication Service Providers (TSP), but, all too often, existing order provisioning processes are fragmented, inefficient, and fail to provide adequate means to verify TSP conformance with these SLAs. TSPs may provide periodic performance reports to their clients to document service support levels, but organizations need a more reliable, proactive means to order and verify that SLAs are being met.

The first embodiment is a web-based application that automates and manages the service order process. The first embodiment is distinguishable from the prior art because it provides an automated system that communicates efficiently and verifiably with TSP Order Handling and Service Provisioning groups.

The first embodiment is an automated, paperless service order process that eliminates the duplicative, time-consuming, paper and fax-intensive processes enterprises are forced to use to request services and obtain service confirmation. The first embodiment provides a turnkey system to manage a laundry list of service requests for such line items as:
Residential installations
Circuit installation (tariff)
Point-to-point T1 networked connections
Telecommunications for commercial, non-government agencies
Installation of video circuitry
In-house services
ISDN-PRI implementation
Disconnections

The first embodiment is XML-driven, flexible and easily customized. It is scalable to meet the unique needs of large, medium, and small organizations. As an XML-based tool, it can easily retrieve and extend data to 3rd party systems. The first embodiment transforms current labor intensive, complex service order processing tasks into automated, secure, efficient and verifiable processes.

The key benefits of the first embodiment include:
Eliminates time consuming manual processes involved in ordering services;
Increases efficiency in the service order process, resulting in better and faster responses from TSPs;
Eliminates rate increases that result from expired contracts not immediately renewed;
Eliminates expenditures for unused services and circuits that have not been terminated;
Facilitates proactive monitoring and verification to hold TSPs accountable for meeting their service commitments; and
Increases overall performance in the distribution of information, and improves the timeliness of receipt of this information for decision makers.

The key features of the first embodiment include:
Enables an organization to seamlessly order and provision any type of telecommunications circuit;
Consolidates and stores orders, circuits, and 3rd party vendor information in a central database;
Facilitates data manipulation through a universal web-based interface Allows close monitoring of all circuit and service contract expiration dates;
Ensures proactive management in renewing or terminating circuit and service contracts as their expiration dates draw near;
Enables comprehensive reporting on all aspects of the provisioning process;
Provides security access control, allowing multiple users concurrent access with rights and privileges assigned according to job function;
Permits access from remote locations, ensuring that provisioning tasks are accomplished anywhere at any time; and
XML and Web services architecture.

Referring now to FIG. 1B, an overview is provided of a second embodiment of the present invention which is used for tracking problems and providing helpdesk-like functionality to an organization.

All too often, large, geographically dispersed agencies have no single point where enterprise network problems can be addressed or where a single Help Desk can dynamically assess the health of the network and its components. Frustration with inconsistent and multi-point Help Desk service is commonplace for users in these organizations. Current products and processes are engineered individually and are not assessed collectively as to their impact on networks and infrastructure. This fragmentation of the Help Desk structure creates significant problems, as service to clients is uneven and inconsistent. Customer Care and Trouble Ticketing Systems (TTS) in large organizations are frequently flawed as a result of:
Dissimilar, non-integrated operation support systems which provide inconsistent and multi-point Help Desk service;
Inconsistent service levels as a result of the independent structure and management of Help Desk systems;
No single point for problem resolution or assessment of program and supporting network health; and
An inability to manage services end-to-end.

The second embodiment addresses these inadequacies by providing a platform to consolidate fragmented Remedy and other Trouble Ticketing Systems. The second embodiment employs IT best practices to streamline and consolidate data collection into a single workflow and brings separate Help Desk processes and functions together. In doing so, it improves IT productivity and efficiency and enables Help Desk personnel to satisfy end users' various requests. Further, the second embodiment unites disparate Remedy systems within one common platform; allowing staff to proactively monitor data and problems for better visibility and control, achieve consistency in management policies and processes and significant savings in costs for licenses, maintenance fees and human resources. The second embodiment enables a proactive, cross-domain system surveillance in real time.

The key benefits of the second embodiment include;
Enables customer-centric focus;
Manages services end-to-end;
Assesses program health and supporting network components from a single point;
Ensures consistent and reliable service through quality control
Consolidates Remedy and other Help Desk/TTS data under one umbrella;
Reduces licensing, maintenance and training costs;
Provides Correlation and Probable-Cause Analysis;
Uses XML, JDBC and ODBC for portability and flexibility; and
Provides seamless integration into third-party applications.

The key features of the second embodiment include:

Consolidate—Collecting data from various fragmented systems allows staff to view additional information relevant to problems within disparate systems. Consolidating data from various systems is prerequisite to meaningful reporting, trend analysis, and correlation.

Expand—Identified fragmented systems are easily accessed, without costly and time consuming licensing and in-house customization.

Extend and Streamline—This second embodiment provides support for XML, JDBC and ODBC that allows staff to extend data seamlessly to third-party tools and applications.

In summary, the second embodiment includes:

1. Consolidated data interface
Source transparency
Proxy to source systems
Improved Mean-Time-To-Resolve
Reduced licensing and training cost

2. Inclusive architecture
Customizable and future proof (XML API)
Data accessible via ODBC & JDBC

3. Complete browser interface
Universal interface to manage data
No client software installation
Easy to use and customizable web interface

4. Read and write data to any source
Level-of-Effort for integration reduced dramatically
XML data easily transformable to other formats (HTML, WAP, etc.)
Extend data to third party systems (Remedy, etc.)

5. N-Tier architecture
Highly scalable
Multi-level data accessibility
Significant savings for initial implementation
Considerate of future expansions

6. Server-based licensing
Future cost containment

7. Functionality standardization

8. Historical Trend Analysis

9. Integration to third party tools and applications

Referring now to FIG. 1C, a third embodiment of the present invention provides for monitoring and reporting network events. A third embodiment employs IT best practices to streamline data collection and consolidate infrastructure and network management into a single, seamless workflow. This embodiment unites disparate management systems within one common platform, allowing access to infrastructure-related data and monitoring of issues for better visibility and control. This unified management system provides proactive, cross-domain surveillance for multi-technology, multi-service and multi-vendor networks in real-time. This embodiment collects and manipulates information, within a single system, enabling critical management data to be:
Consolidated—Collecting data from disparate sources into one viewing model enables you to perform new correlations between network and system events.
Expanded—As new technologies and products emerge, you need a system that can incorporate them without costly upgrades or additional in-house modification or development. With this embodiment the user is in complete control of the integration with other management systems. With this embodiment's built-in flexibility, it is possible to easily expand data parameters or incorporate new technologies and requirements.
Extended—This embodiment provides support for XML, JDBC and ODBC allows extending consolidated data seamlessly to external systems

This embodiment is a web-based application that easily connects to core management systems, providing instant visibility into all monitored network elements. In delivering these features through a Web interface, this embodiment is easily accessible across different platforms from the network control center during the day and during off hours.

The key benefits of this embodiment are:
Consolidates management data under one umbrella
Reduces licensing and training costs for existing network management systems
Provides proactive management of infrastructure
Enables Probable-Cause correlation and analysis
Presents a personalized view of network performance and service availability
Uses XML, JDBC and ODBC for portability and flexibility
Provides seamless integration with third party applications
Monitors infrastructure remotely through an easy-to-use browser interface
Takes advantage of scalable N-tier architecture

The key features of this embodiment include:

In summary, the third embodiment includes:

1. Consolidated data interface providing:
Source transparency
Proxy to source systems
Improved Mean-Time-To-Resolve
Reduced licensing and training cost Inclusive architecture
Customizable and future proof (XML API)
Data accessible via ODBC & JDBC
Effective management of network technology transition

2. Complete browser interface providing:
Universal interface to manage data
No client software installation
Easy to use and customizable web
interface

3. Read and write data to any source providing:
Instant access to service availability
Level-of-Effort for integration reduced dramatically
XML data easily transformable to other formats (HTML, WAP, etc.)
Extend data to third party systems (Remedy, etc.)

4. N-Tier architecture providing:
Highly scalable
Multi-level data accessibility
Significant savings for initial implementation
Considerate of future expansions

5. Server-based licensing providing:
Immediate ROI in elimination of third party vendor client licenses
Number of users per server is limited by the hardware constraints
Future cost containment

6. Java (J2EE) and Windows 2000 versions

7. Functionality standardization

8. Historical Trend Analysis

9. Integration to third party tools and applications

FIG. 1C and 1D respectively provide an overview and an in-depth view of the features and architecture of the third embodiment of the present invention which allow the present invention to collect data from external sources, convert the data into a common model, and store it in a relational database, thereby allowing users to define the way they would like to view the data.

The operational concept behind the present invention is:

collect data 120 from external sources 101-105, convert the data into a common data model 107 and store it in a relational database 108,

users define the way that they would like to view the converted data, and

publish the converted data 119 using a browser interface through XML, XSLT transformations, and SQL queries.

Collectors are used to extract data from data sources such as NetExpert©, NetCool©, HP OpenView©, and other operations support systems. The extracted data is converted into a common model using XML, which is passed to the Alert Reader to be saved into a relational database, such as Oracle or SQL Server.

The data collected in the relational database enables the present invention to respond to requests via the Query module. These requests are to retrieve subsets of the data defined by the users as views and filters. Query results are produced as XML, styled using XSL, and sent to the user's browser. Browser receives HTML to display the results of the query without having to run Java Applets or ActiveX objects.

Publishers allow modified data to flow from the present invention back to the source. Only the authorized users who have valid accounts on the source system can perform publish functions.

The integration of Operation Support Systems (OSS) systems poses a complex problem. Moreover, costs of licenses, maintenance fees, and training for day-to-day use are often prohibitively expensive. The present invention is a Web-based application that interfaces easily with existing management systems to provide instant visibility into all monitored network elements and events. It is an advanced, multi-vendor management system designed to increase efficiency and productivity and reduce network administration costs by providing an integrated system for monitoring, troubleshooting, and managing the network. An object of the present invention is to unite different management systems under one common, user-friendly platform. Therefore, the present invention collects and manipulates information centrally, within a single system, enabling critical management data to be shared seamlessly between applications. This provides-—
Data Consolidation—Collecting data from disparate sources into one view enables the user to perform new correlations between events generated by different systems.
Data Extendibility—Collecting data under one umbrella allows the user to make important information available to external systems or applications, thus extending the use of all resources.
Reduced Cost—Return on Investment is immediately realized through reduced costs for software licensing and administrative training for multiple applications. A Web-based interface is transparent and easily accessible across different platforms.

The present invention is a “Manager of Managers”.

The underlying concept of the present invention is to collect data from external sources, convert the data into a common model, and store it in a relational database. Then, allow users to define the way they would like to view the data, and display the results through a browser interface. The present invention accomplishes this by making broad use of extensible Markup Language (XML), extensible Style Language Transformation (XSLT), and structured query language (SQL) queries.

Collectors are used to extract data from such sources as NetExpert©, NetCool©, HP OpenView©, and similar software packages. The extracted data is converted into a common model using XML, which is passed on to the Alert Reader to be saved into a relational database, such as Oracle or SQL Server.

The data collected in the relational database enables the present invention to respond to requests via a Query Module. These requests retrieve subsets of the data defined by users as views and filters. Query results are produced as XML, styled using extensible Stylesheet Language (XSL), and sent to the user's browser. Using HTML, the browser displays the results of the query without having to run Java Applets or ActiveX objects. Figure ID illustrates this process.

The key features of the present invention are:
1. Collectors and Publishers

The Collector is a highly configurable program that extracts data from a source. Using configuration parameters, connection information about the data source, the query command, and the XML output definition can be specified. In a similar way, Alert Writer is configured to read the data in XML and store it in a database.

The Collector and Alert Writer modules allow users to transport data from diverse systems and store it in the database. Users can create and populate custom fields from external sources by specifying fields in the Collector's and Alert Writer's configuration files.

Publishers allow modified data to flow from the present invention back to its original source. Only authorized users who have valid accounts on the source system can perform publishing functions.
2. Users and Groups

The present invention allows administrators to create groups within the system. Each group is assigned a manager who is responsible for adding and maintaining users for that group.

Each group is restricted to a subset of the common data, and all members of the group, including the manager, inherit this restriction. This permits service providers to make data available to their external customers without compromising sensitive data restricted to other customers or groups.

The group manager can create additional restrictions for individual users within the group.
3. Views and Filters

Views allow a user to specify which columns to display, the order in which the columns are displayed, and how to sort the results. Filters enable users to specify criteria for retrieving data. Users specify multiple criteria through the use of AND/OR key words; combinations of these criteria can be further grouped using left and right parentheses. Users are also allowed to create and modify views and filters for the datasets available to them.
4. Tools

In all embodiments of the present invention, administrators can specify parameters to be sent to external applications by selecting columns from the common database. The data is formatted by the system into XML or HTTP value pairs and passed to a URL specified through the Tools Interface.
Architecture

All embodiments of the present invention work with a plurality of different environments and customer requirements. This approach enables users to customize embodiments of the present invention according to specific data and integration needs. The ability to deploy embodiments of the present invention in UNIX or Windows environments gives users maximum platform independence.

N-Tier architecture is a main focus of both the UNIX and Windows implementations of all embodiments. In the Windows version, the present invention works within Window's Component Services. The Active Server Pages (ASP) engine in the Internet Information Server (IIS) interacts between the user and components of the present invention.

The UNIX version was developed using J2EE technology and uses an API to host all Enterprise JavaBeans (EJBs), Beans, and Java Server Pages (JSPs) that tie the Display Engine to the Query Engine.

A relational database such as Oracle or Microsoft SQL Server is used the present invention to store and process data. The Collector Engine ties each user's management systems to data of the current invention by converting the Open Database Connectivity (ODBC) or Java Database Connectivity (JDBC) data source into XML. Alert Reader uses the XML format to accept data into all embodiments of the present invention, enabling data to be transferred easily from any management source into the data definition of the present invention, see Figure ID.

To provide the simplest access to the system and allow users to take advantage of advanced user interface features, the user interface of the present invention is based on Hypertext Markup Language (HTML) and some Dynamic HTML (DHTML). Differences between Netscape and Internet Explorer browser implementations are kept to a minimum by using DHTML features common to both.
Technology

1. Collectors and Publishers

Collectors and Publishers are the means by which the present invention communicates with its data sources. Collectors can read data from any ODBC and JDBC data source and translate it into XML as input for the Alert Reader component.

The data model of the present invention is adaptable to modifications that may be required by different environments and organizations. The data model of the present invention is provided in an Alert Writer configuration file so that the system knows where the incoming data needs to be placed in the database. The mapping of the incoming XML data to the data model of the present invention is also specified in this configuration file, see FIG. 1E.

Similarly, the Collector configuration file specifies which fields to extract from the data source and then maps these fields according to XML attributes. This allows the user to extract only required fields and provides the flexibility to capture additional fields in the future.
Components

Using components developed as Component Object Model (COM) objects or as EJBs, the present invention is architected as a component-based system, see FIG. 1F. Main components, such as Filter, View, Query, User, and Group, are invoked by the Display Engine to satisfy a user's requests. The Display Engine processes the user's HTTP request and dynamically renders the pages. The data exchange between the Query components and the Display engine occurs in XML, allowing the Display Engine to render the data into any form through an XSLT processor. The Display Engine communicates directly with the Filter, View, User, and Group components to perform edits to definitions.

Query interacts with the Filter, View, User, and Group components to process queries, see FIG. 1G. Filter and View components provide the necessary information to build the query; User and Group components provide the user's access and data retrieval privileges. The dictionary component inserted between all of these components is used to translate database fields into meaningful, user-friendly field names and descriptions.
User Interface

When the Display Engine dynamically renders the page by transforming XML data through the XSLT process, the resulting page is sent to the browser as HTML/DHTML content. All embodiments of the present invention make the data as accessible as possible for all client platforms and configurations by keeping the output format simple and configurable.

Transforming View and Filter data into HTML allows many browsers to access the data—even over a dial-up connection—without having to install Java or ActiveX components on the client server or workstation. This enables users to access information anywhere, anytime. Transforming XML data through the XSLT processor also enables developers to transform data into formats other than HTML, including the Wireless Application Protocol (WAP).
Data Repository

The Open Architecture model of the present invention allows users to store their data in a relational database of their own choice, such as Oracle or SQL Server. Users may then employ additional reporting tools or develop custom programs to further process the consolidated data.

Customers may modify parts of the data model of the present invention according to expanded or increasing requirements, which, in turn, will reflect the changes made in the dictionary. The flexible, adaptable, and easy-to-use system permits users to add new fields in the data model and assign user-friendly names to them without having to make programming changes.

### SUMMARY

The present invention is a scalable set of embodiments that is an inclusive architecture solution for bringing diverse management systems together under one umbrella and enabling ease of access to consolidated data. The extendibility of the present invention, allowing the user to import additional sources and adjust the data model without an extensive development effort, makes the present invention a powerful tool for long-term use. Furthermore, the present invention's extensibility—through data transformation into other formats, and data extraction using the COM, EJB API, or the Tools interfaces of the present invention to send data to other Web-based systems—provides a powerful means to control and oversee a diverse range of management systems.

An object of the present invention is to provide an open, extendable and extensible system that can receive input from any source and provide output to any interface.

Another object of the present invention is to provide a system that can unify event data from different sources under a single interface.

Still another object of the invention is to provide an expandable system that can accommodate new properties introduced by new data sources.

Yet another object of the invention is to provide a system that can provide the necessary performance and responses under large volumes of both stored and incoming data.

Another object of the present invention is to provide an intuitive interface that gives the systems' users the functionality they need.

Additional features and advantages of the invention will be set forth in the description which follows, and in part will be apparent from the description, or may be learned by practice of the invention. The objectives and other advantages of the invention will be realized and attained by the structure particularly pointed out in the written description as well as the appended drawings.

The present invention was designed to provide a unified system through which user helpdesk requests, telecommunications provisioning requests, network monitoring alerts, configuration management requests, and other such events that typically flow into different fault and performance management systems can be accessed under a common interface. In a preferred embodiment, the interface is provided through an interface based on the Hypertext Markup Language (“HTML”), extensible Markup Language (“XML”), or another Standardized Generalized Markup Language (“SGML”) derived language.

The present invention is also designed to be extensible, thus allowing it to receive data from new data sources in accordance with a company's requirements. This allows data to be collected and manipulated from one interface, thus reducing the cost of licensing and training staff for multiple applications. Collecting event data under one umbrella also allows the present invention to make the event data, and any analyses thereof, available to other external systems or applications, thus extending the use of the event data.

The present invention was initially designed for use by telecommunications companies, and while the description herein focuses predominantly on the use of the present invention by such companies, it should be apparent to one skilled in the art that the present invention can be advantageous to any organization seeking to consolidate its disparate event monitoring under a single application. By way of example, without intending to limit the present invention, telephone companies may benefit from the present invention because they already deploy and use a variety of event-generating systems, including provisioning systems, trouble ticket/helpdesk systems, network status monitors, and the like. The present invention is designed to take data from these disparate sources and to consolidate the event data under a single application, thereby reducing licensing and training requirements. Other advantages will be apparent to one skilled in the art.

Table 2, provides additional details on the features of the system.

TABLE 2

| Item | Feature |
|---|---|
| 1 | System should contain the most current data provided |
| | from all external data sources |
| 2 | System should be able to perform 1,000 updates per minute |
| 3 | Historical information should be provided only if the external |
| | systems are capturing and maintaining that information |
| 4 | Application should provide different levels of access to the system |
| 5 | Changes to an alert should be propagated to originating system |
| | then to the current system and then to the User's browser |
| 6 | Users should be able to setup several filters and save these filters |
| | in their profile for later use |
| 7 | Users should be able to setup several views and save these |
| | views in their profile for later use |
| 8 | Users should be able to apply different filters to a view |
| 9 | User with appropriate privileges should be able to take ownership, |
| | acknowledge, de-acknowledge, delete and change priority of |
| | messages |

Object Model—the following sections provide an overview of an object model of a preferred embodiment of the present invention.

Collectors—Collectors' main functionality will be to query the data source and provide an XML output.

1. These collectors will have to be light and very fast.

2. These collectors will have to be configured for each source since each source can reside on a different database with a different data model.

3. Collectors will transform these external data models into the common data model via XML.

4. Collectors will be executed periodically by the system.

Publishers—Publishers will work the opposite direction of the collectors.

1. These objects will receive an XML input and they will transform this data back to the data source's data model and perform updates on that database.

2. Even though these objects will also need to be lightweight and fast, they will not deal with the same number of records as the Collectors will.

3. Publishers will be executed on demand.

Alert Writer—Alert Writers will receive alerts as an XML input, will parse and validate the information and insert or update the records on the system's database.

1. This object will have to be optimized for speed and will have to perform 1,000 transactions per minute.

2. This object will be executed on demand (possibly by Collectors).

Alert Query—This object will perform queries on the database based on the user, requested view and filter.

1. Result of the queries will be provided as an XML output.

2. May run multiple view/filter queries for a given user and return the results in a combined XML statement

Display View—This objects responsibility is to process user's ‘view’ requests.

1. User may request multiple views to be displayed on their browser

2. Object performs formatting of the XML data for a view or multiple views using XSL.

Navigation—This object determines the site navigation and available options for the user.

1. Some of the navigation/feature options will be common to all users or user groups.

2. Some of the navigation/feature options will be specific for a particular user.

Filter—Filter object is used for manipulating the filter information.

1. This object is used to create, edit and delete filters

2. Retrieve a specified filter or filters. If no filter is specified return the default filter for the user.

dbFilter—This objects sole responsibility to handle database connectivity and communication responsibilities for the ‘Filter’ object.

View—Filter object is used for manipulating the view information.

1. This object is used to create, edit and delete views

2. Retrieve a specified view or views

3. Filter associated by each of the views being retrieved. If no specific filter is specified, the default filter for the view will be requested.

dbView—This objects sole responsibility to handle database connectivity and communication responsibilities for the ‘View’ object.

AlertUpdate—This object will be responsible propagating the ‘alarm management’ functions to alarm's originator, to the current system and to the user's browser.
Interface

The interface will support standard web browsers such as Internet Explorer 5.×and Netscape 6.×.

System will be designed to support 800×600 screen resolution. Users who set their resolution below this number may have to scroll left to right.

Menu—Menu will always be visible on the top of the screen on the event that the user has to scroll the page up and down.

Menu will contain items that are common to all users as well as items that are specific to a particular user (such as the filter and view names)

Admin Menu will be available to users who belong to the Admin and Manager groups.

View—Users will be able to add up to 3 views on their browsers. All these views will be refreshed when the user manually or the browser automatically refreshes the page.

Users will be able to collapse, minimize or close views that are on the browser, arrange them by moving them around, and click on them to make them the active view (inactive views will still be refreshed).

Regardless of that the resolution is set, if the user has two or more views on the screen, it may be necessary to scroll up and down to be able to see all open views. However, a single open view will fit into 800×600 resolution.

Users will be able to apply filters to the active view. If there is only one view on the screen, this view will be active.

Columns on the views will be clickable to sort the view for that column. The next consecutive click on that column will sort the data for the same column but the opposite sort direction. Columns will be sorted ascending first and descending next. Up arrow and down arrow icons will be shown next to the column header indicating which direction the data is sorted.

Users will be able to specify the default sort order for each view.

The title of the view will be the name of the view plus the name of the filter. The color of the view title will be based on the color of the highest severity displayed on that view.

A user configurable parameter for views will determine the number of records shown on a view before a scrollbar is used to scroll up and down. In addition, there will be a ‘next set of records’ and ‘previous set of records’ navigation controls based on the number of records sent by the web server from the record set produced by the filter. Web server decides the number of records to be sent to the browser from another user maintained parameter.

Users will be able to click on a specific alert and get the details for that alert. The Alert detail will be displayed on a popup window. Users will be able to click on the close button to close this window to get back to the main window.

Filter—Administrators, managers and users will be able to create filters based on the available columns.

Administrators and managers will be able to create filters to limit the dataset available for the users to see. Any filter created by an administrator or a manager will not be visible or editable by the users.

Administrators can create filters for managers where the managers cannot see or modify this filter and this filter is carried over to any user that the manager creates.

Any filter that is created by either an administrator, manager or by a user can be saved under a particular name.

The named filters can be associated by any view as the default filter.

The named filters can be applied to any view while the view is being displayed on the browser.

Users can edit and delete the views that they have created.

Filters can contain multiple fields connected by ‘and’ and ‘or’ operators. Users can also use the left and right parentheses to group the fields. System will perform a simple check on the count for left and right parentheses for validation.

Filters will perform case in-sensitive searches where the users will not have to worry about if the value exists in the database in upper case or lower case or mixed case.

System Administrators will be able to map the systems internal field names to another set of values. These values will be visible on the views, filter builder and other places where the data model is exposed to the interface.

System will perform a data type validation on the values specified for filter columns to make sure that a valid date is specified for date columns and a numeric value is specified for number columns.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIGS. 1A-1&2, 1B, and 1C respectively illustrate a first, a second and a third embodiment of a system according to the present invention.

FIG. 1D provides an detailed view of the architecture of the third embodiment of the present invention;

FIG. 1E illustrates collector and alert writer mapping of the third embodiment.

FIG. 1F illustrates data exchange between the query components and the display engine.

FIG. 1G illustrates query interaction with the filter, view, user and group components.

FIG. 2 is a block diagram providing an overview of a web site interface to the underlying data.

FIG. 3 is a block diagram representing an object model for the system.

FIG. 4 is a block diagram representing additional object models for the system. [0027] FIG. 5 is a block diagram illustrating a preferred user interface data flow.

FIG. 6 is a block diagram illustrating a preferred data flow when a user chooses to open a view.

FIG. 7 is a block diagram illustrating a preferred data flow when a user chooses to close a view.

FIG. 8 is a block diagram illustrating a preferred data flow when a user chooses to apply a filter.

FIG. 9 is a block diagram illustrating a preferred data flow when an alert occurs.

FIG. 10 is a block diagram illustrating a preferred data flow when a user creates a new filter.

FIG. 11 is a block diagram illustrating a preferred data flow when a user edits an existing filter.

FIG. 12 is a block diagram illustrating a preferred collector data flow.

FIG. 13 illustrates an implementation of the first embodiment.

FIG. 13A is a table format for routing information for the implementation of FIG. 13.

FIG. 13B illustrates e-mails formats for the implementation of FIG. 13.

FIG. 13C illustrates XML for data posted for vendor consumption by the implementation of FIG. 13.

### DETAILED DESCRIPTION OF THE PREFERRED EMBODIMENT

Reference will now be made in detail to the preferred embodiments of the present invention, examples of which are illustrated in the accompanying drawings.

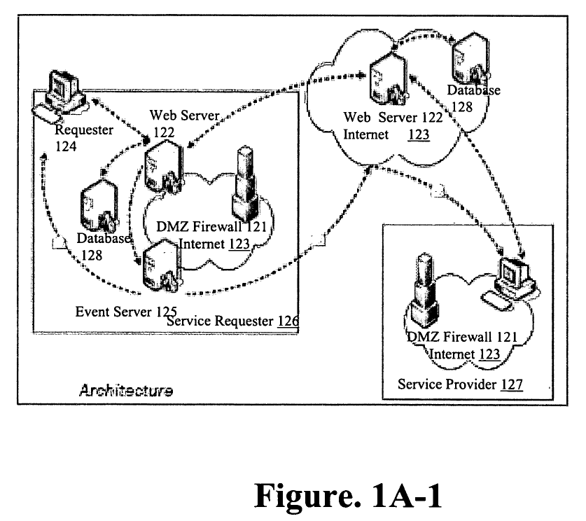

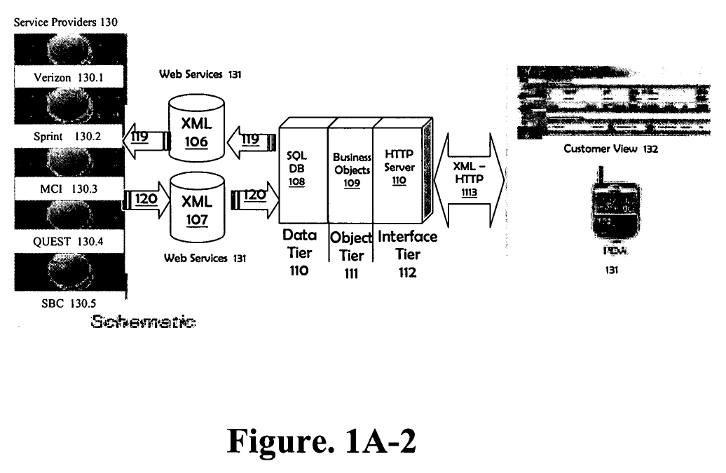

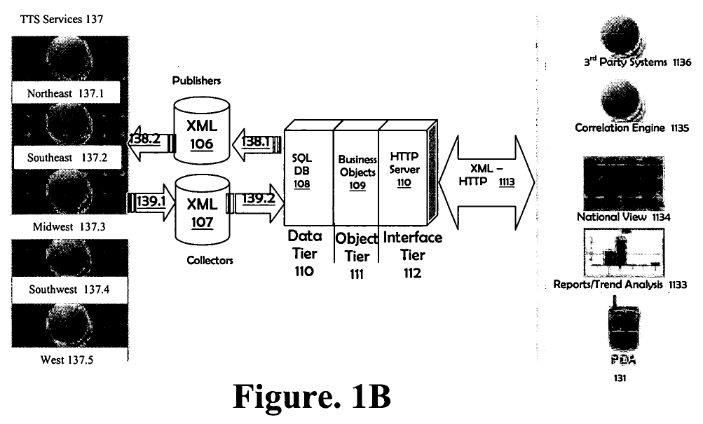

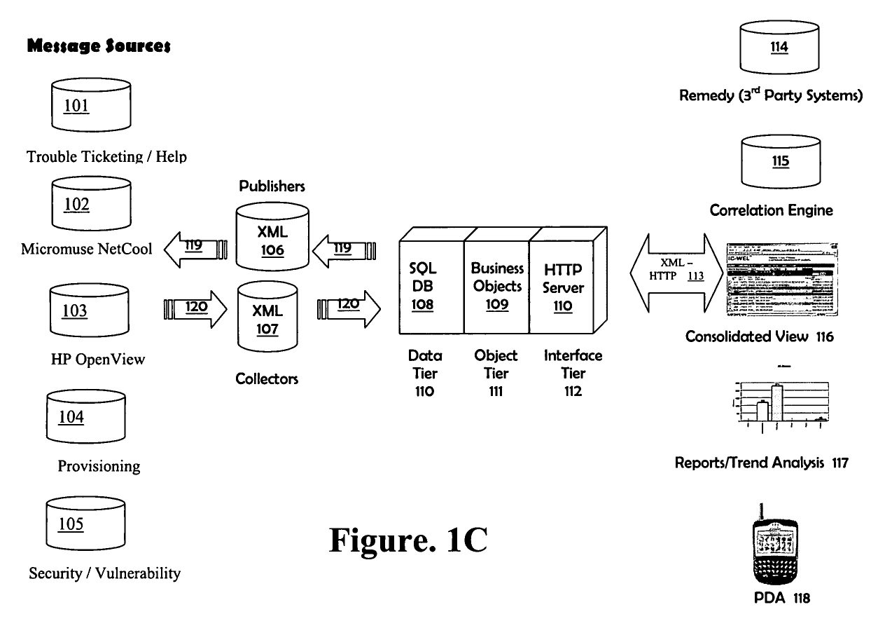

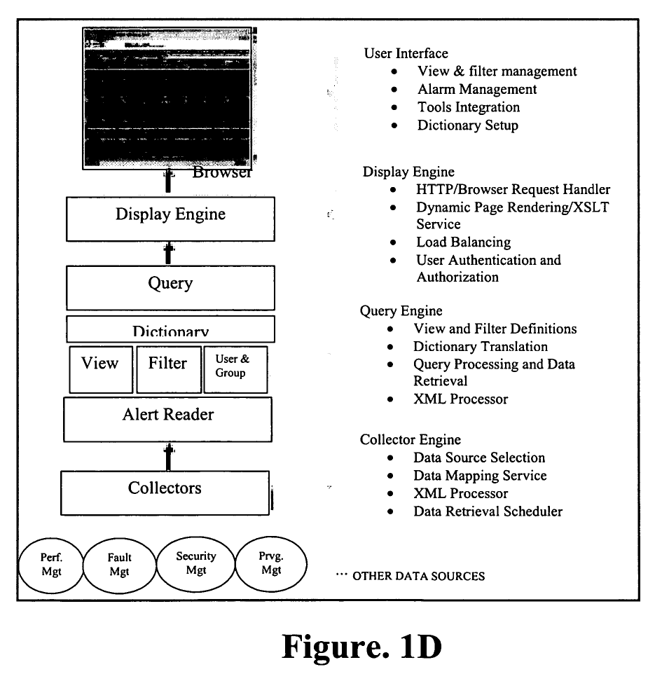

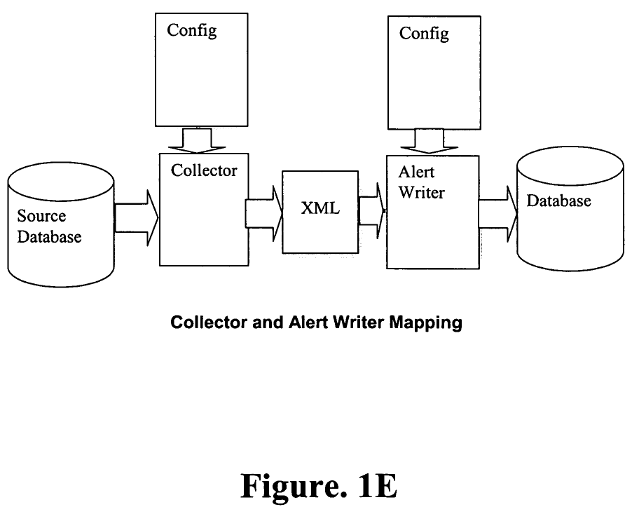

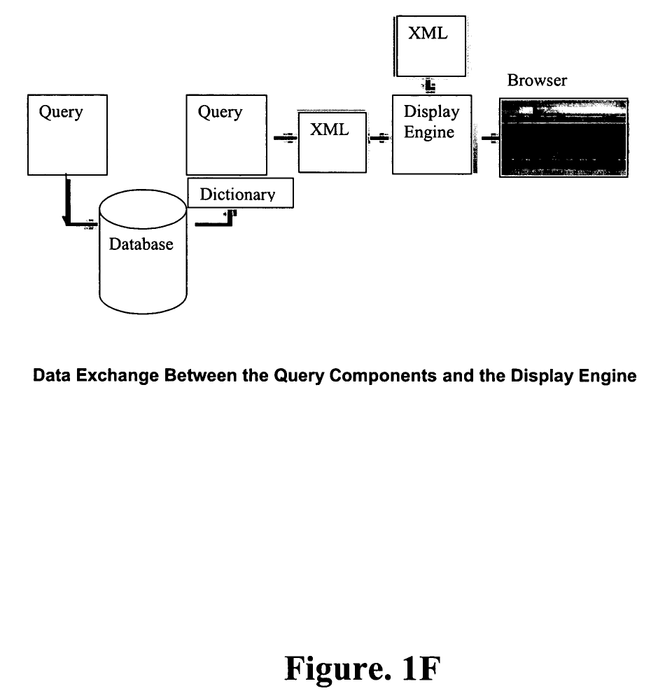

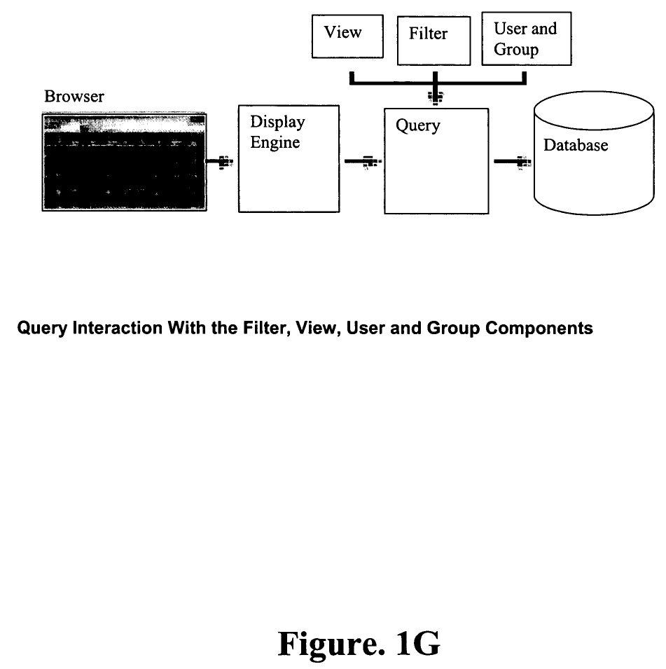

The present invention is designed to receive event data from a variety of sources and to provide a common interface to such data. FIG. 1 is a block diagram providing an overview of one architecture through which the system can be implemented. This architecture allows the present invention to achieve at least two goals:

1. Data Source Independence, and

2. Platform Independence.

One means for achieving the first goal is by implementing a unified data architecture using XML. Highly customizable “collectors” can be developed to gather the most recent information from the disparate data sources, and these collectors can transform the data such that it is consistent with the unified model. Collectors can be written in any language for any platform since their output will be a common XML output.

The second goal can be achieved through utilizing common protocols for communication between the programs and databases. By way of example, without intending to limit the present invention, one embodiment of the present invention uses Simple Object Access Protocol (“SOAP”) to communicate between data sources, internal databases and internal programming logic. The system will preferably use a relational database, such as an Oracle database and SQL Server, for event data storage. Such a database may be runs on a variety of platforms including Solaris, LINUX, Windows NT/2000IXP and IBM OS390. The system will also preferably support the latest versions of Netscape and Internet Explorer for the interface. Although specific databases, protocols, hardware, and operating systems are described above, it should be apparent to one skilled in the art that alternative databases, protocols, hardware, and operating systems may be substituted therefor without departing from the spirit or the scope of the invention.

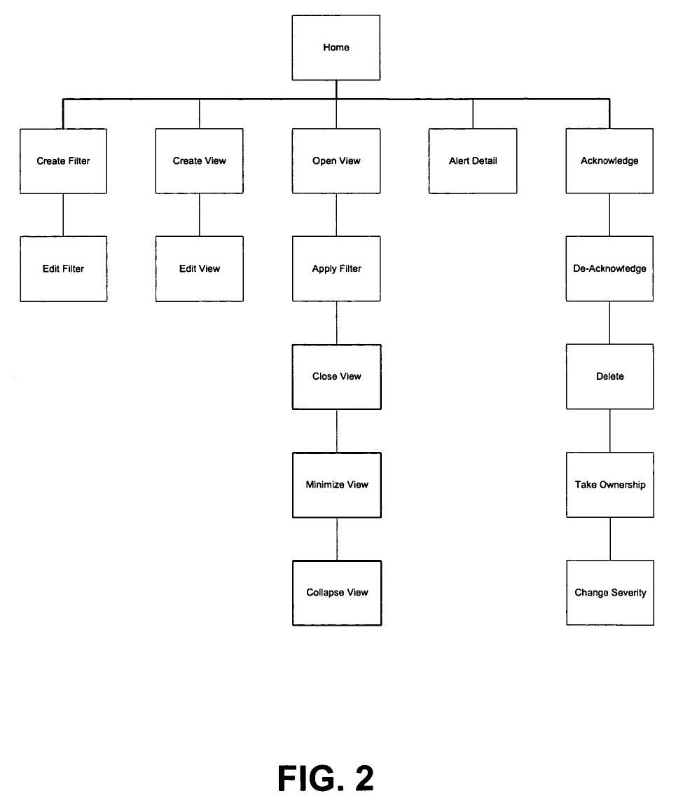

FIG. 2 illustrates the Major components of the user interface in a main page, which contains a menu and a view grid, popup window to display alarm details, and several popup windows to mange views, filters, users, groups, dictionary fields, etc.

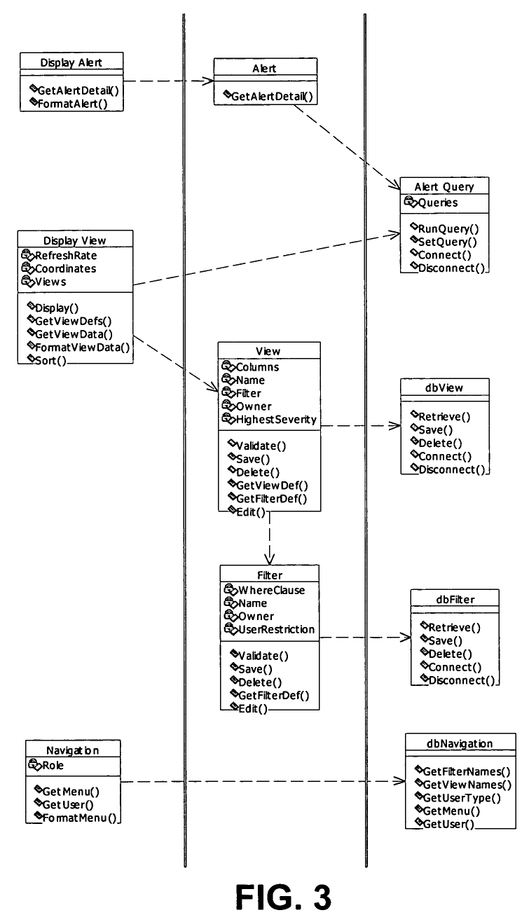

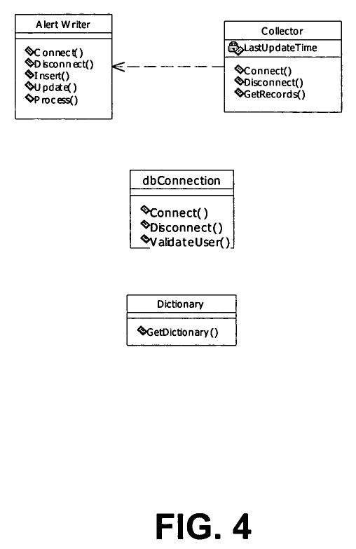

FIGS. 3 and 4 provide an overview of an object model used in a preferred embodiment of the system.

The following sections provide additional definitions of some of the objects implemented as part of a preferred embodiment of the present invention. It should be apparent to one skilled in the art that alternative objects can be substituted therefor without departing from the spirit or the scope of the invention.
Navigation Object
GetUser

The web server will first authenticate users. This user name will be passed through the GetUser method of the navigation object to validate the user. If the user is valid, then this user information will be used to build the menu for the user. GetUser will invoke the GetUser method of the dbNavigation Object.
GetMenu

Each menu will have common menu items, and user dependent menu items. If the user is authenticated, the view names and filter names that this user has created will be added to the common menu. Based on the user's Admin/Manager/User privilege, the Admin menu will be either visible or invisible to the user.

Table 3 defines the menu and menu items required by the system.

TABLE 3

| Alarm | | | | |
|---|---|---|---|---|
| Management | Tools | View | Filter | Admin |
| Acknowledge | Email | Create View | Create Filter | User |
| | | | | Management |
| Change Severity | Ping | Edit View | Edit Filter | Create Tools |
| De-Acknowledge | | — | — | System Setup |
| Delete | | List of | List of | |
| | | user views | user filters | |
| Take Ownership | | | | |

### Table 3

GetMenu invokes the GetMenu method of the dbNavigation object. This object returns the menu and the menu items in XML format.
FormatMenu

This method converts the XML menu into DHTML menu that stays on the top of the window at all times.
Display View Object
Display

Display function will extract information for the views that are being displayed, the active view, filters that are currently being applied to these views and if there is apply a new filter request and who is making the request (from the navigation.GetUser).

Display view then makes a call to the GetViewDefs method, which invokes the GetViewDefs method of the View object.

Once the query definition is received, it will be executed using the AlertQuery object's RunQuery method.

Obtained results will be formatted using an XSL style sheet and converted to HTML/DHTML and sent to the user's browser.
Sort

Will set the parameters that will override the default sort order for the active view.
GetViewDefs

GetViewDefs will expect to receive an XML data to be returned that fully describes the columns to be displayed, how the selection is going to be made and how the information is going to be sorted.
GetViewData

This method will invoke the AlertQuery object's Run query method and pass all the necessary information to perform the query. It will receive an XML result set.
FormatViewData

This method will apply the specified style sheet to the XML data obtained by the GetViewData method in order to convert it into HTML (or other formats in the future, such as WAP, etc.). An error page will be displayed if there are no results to be converted to HTML.
View Object
GetViewDefs

This method invokes the dbView object and requests view definitions for a list of views. The definitions that are returned from the dbView will contain the columns to be displayed to the user on each view, the order of the columns to be displayed, and the default filter names (or ids) for each of the view.

This method then calls the GetFilterDefs method and passes either the default filter names (ids) for the views or passes the ones that may have been requested from the browser.
GetFilterDefs

This method calls the GetFilterDefs method of the dbFilter object and retrieves the filter criteria. User information is also passed along to the dbFilter object for that object to determine all the Admin and manager filters that are applied for that user.
Filter Object
GetFilterDefs

Calling function may request filter definitions for multiple filters by passing filter names (or ids). This method calls the dbFilter object's GetFilterDefs to get the data from the database. It is also dbFilter objects responsibility to determine the filters (data restrictions) that are setup by the administrators and managers for that user and incorporate them to the filter statement. The resulting statement would look like ‘AdminFilter AND ManagerFilter AND RequestedFilter’. If there are no filters setup by the administrators or managers then those filters will not be incorporated into the overall statement.
New

This method will initialize the object and set the default values, such as, the user name, create date etc. During the initialization, filter will be also tagged to be a regular user filter or a admin/manager restriction for a user.
Save

This method will first call the validate function to validate the “WHERE” clause to determine if it is properly formed (i.e., left and right parenthesis are properly closed, criteria values properly formatted for strings, dates and numbers etc.) This function calls the dbFilter objects Save method and passes the filter information to be saved. Only the dbFilter object is responsible to determine if this is an update or an insert transaction and execute the transaction.
Delete

This method will call the delete method of the dbFilter object and pass the name (id) of the filter name to be deleted. The dbFilter object will delete the filter. Admin and manager filters are not visible by users and can not be deleted by users.
Collector Object

Collector object is a highly configurable object that can connect to any JDBC/OLDEB/ODBC source, perform an SQL query and save the results in a file in XML format defined in the configuration parameters.

Object's ‘Init’ method sets the connection parameter for the source, creates a record set using the SQL statement specified in the configuration file, maps the record set's columns to XML elements. The ‘RunQuery’ method opens the record set and saves the data into an XML file. ‘RunQuery’ accepts an argument that specifies the time and date. If the argument is not null, query selects the records with ‘StateChange’ greater and equal to the value passed as the argument.
AlertWriter Object

AlertWriter object is a highly configurable object that connects to the database, parses the XML input and performs insert and update queries as defined in a set of configuration parameters.

Object's ‘Init’ method sets the connection parameter for the data source, reads the insert and update statements to be executed, and maps the insert and update statement's columns to XML elements. The ‘Save’ method performs the inserts and updates against the database. An XML data file is passed to the ‘Save’ method. Upon successful completion of processing the file, this input file is deleted.

FIG. 5 is a block diagram illustrating a preferred user interface data flow. When the user comes to the home page, the system preferably first authenticates the user. For an authenticated user, the present invention will preferably build a menu for the main page using the Navigation object's GetMenu method. Once the menu is built, DisplayView object's Display method is preferably called. Display method preferably accepts an array of names (or ids) of the views and the array of names of the filters for each of the views as arguments (or null values for either array). Null view value with null filter argument will preferably result in displaying the default view with the default filter for the user.

Display method invokes the View object's GetViewDefs methods and will pass either null or the names of the views and the names of the filters that the view definitions are requested. View Object uses the dbView object to retrieve the view information from the database. XML formatted return information will also contain the names of the default filters for each of the views.

View object instantiates Filter object and calls the GetFilterDefs method. Default filter names that are returned from the View.GetViewDefs are passed as an argument to this method if no filter arguments were received. Filter object gets the filter definitions using the dbFilter object and returns the results formatted in XML. Now that the View object contains the complete view definition, process returns to the DisplayView object.

DisplayView Object makes a call to the AlertQuery object, passes the view definitions and waits for the XML formatted results. This XML formatted results are passed through the FormatViewData method of the DisplayView object to format them to DHTML.

Display method preferably invokes the View object's GetViewDefs methods and will preferably pass either null or the names of the views and the names of the filters that the view definitions are requested. View Object can use the dbView object to retrieve the view information from the database. XML formatted return information will also contain the names of the default filters for each of the views.

View object instantiates Filter object and calls the GetFilterDefs method. Default filter names that are returned from, the View.GetViewDefs are passed as an argument to this method if no filter arguments were received. Filter object gets the filter definitions using the dbFilter object and returns the results formatted in XML. Now that the View object contains the complete view definition, process returns to the DisplayView object.

DisplayView Object makes a call to the AlertQuery object, passes the view definitions and waits for the XML formatted results. The XML formatted results are passed through the FormatViewData method of the DisplayView object to format them to DHTML.

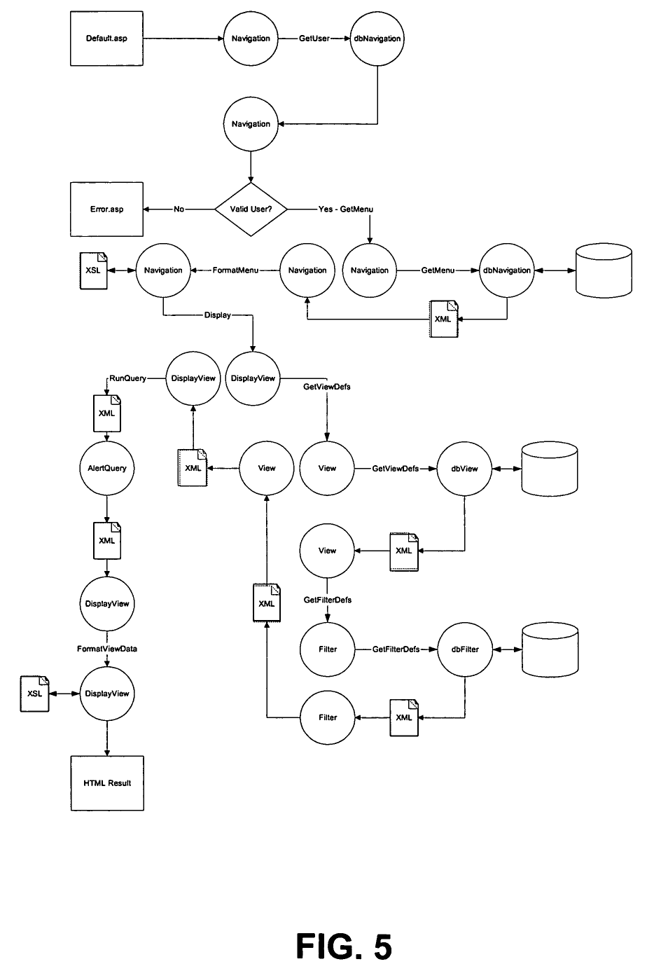

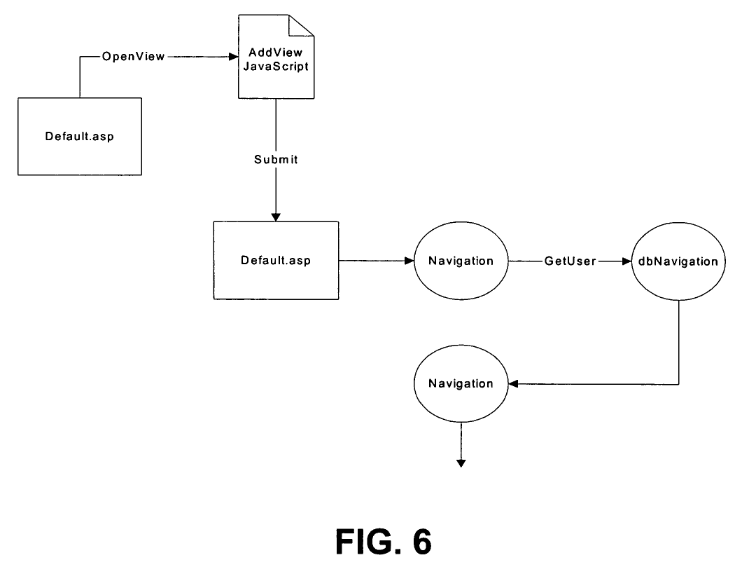

FIG. 6 is a block diagram illustrating a preferred data flow when a user chooses to open a view. When a user clicks on the “view” menu and selects a named view, the OpenView function is preferably called. This function will preferably be implemented on the client side. The function will modify the variable that holds the views to be displayed and add the view name (or id) to this variable. The data is submitted to the default page.

Home functionality defined above will be executed. In this case, instead of null view names (or ids), the names (or ids) of the views will be passed to the DisplayView object's Display function.

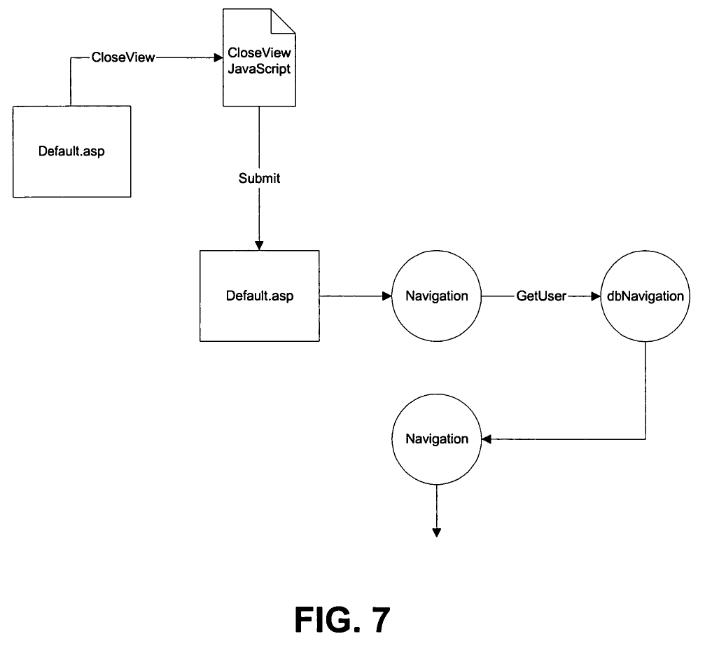

FIG. 7 is a block diagram illustrating a preferred data flow when a user chooses to close a view, such as, but not limited to, by clicking on the “x” button in a view. The CloseView function is preferably called when the user takes this action. This function will preferably be implemented on the client side. The function will modify the variable that holds the views to be displayed and removes the view name (or id) from this variable. The data is submitted to the default page.

Home functionality defined above will be executed. In this case, instead of null view names (or ids), the names (or ids) of the views will be passed to the DisplayView object's Display function.

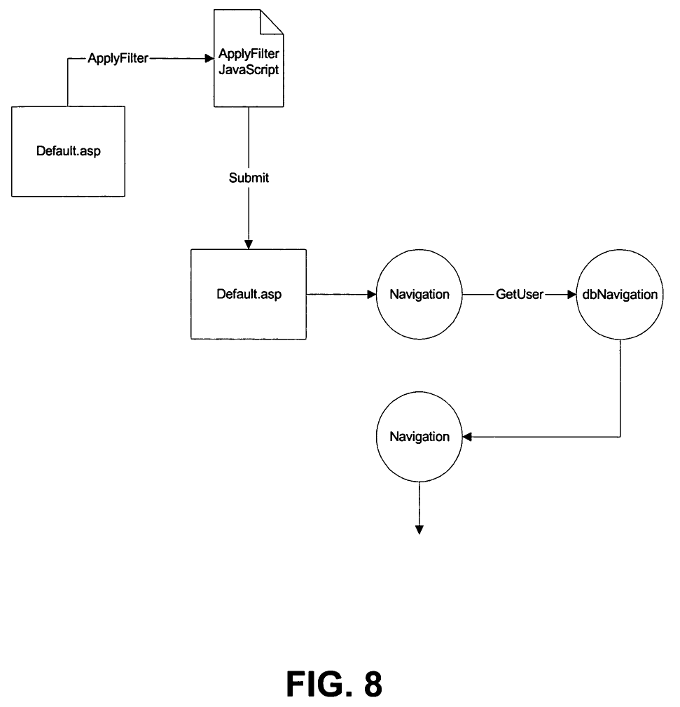

FIG. 8 is a block diagram illustrating a preferred data flow when a user chooses to apply a filter, such as when a user clicks on the “filter” menu and selects a named filter. The ApplyFilter function is called when the user takes this action. This function will preferably be implemented on the client side. The function will modify the variable that holds the filters and changes the filter name (or id) for the active view. The data is submitted to the default page.

Home functionality defined above will be executed. In this case, instead of null view names (or ids), the names (or ids) of the views will be passed to the DisplayView object's Display function along with the filter names (or ids).

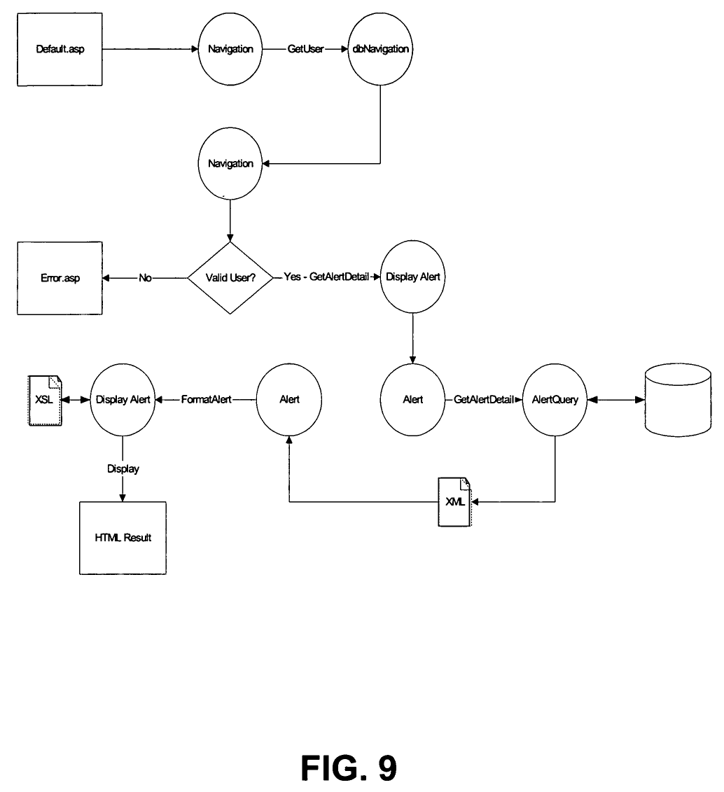

FIG. 9 is a block diagram illustrating a preferred data flow of alert detail provided when an alert occurs. The alert details will open as a popup window and display the full details of the alert.

This window will not refresh itself. A close button will enable users to close this window and go back to the Home page or the last page viewed.

Minimize View—This will be a dynamic HTML feature where the layer that is displaying the view will be minimized.

Collapse View—This will be a dynamic HTML feature where the layer that is displaying the view will be collapsed where only the title bar or the window is visible.

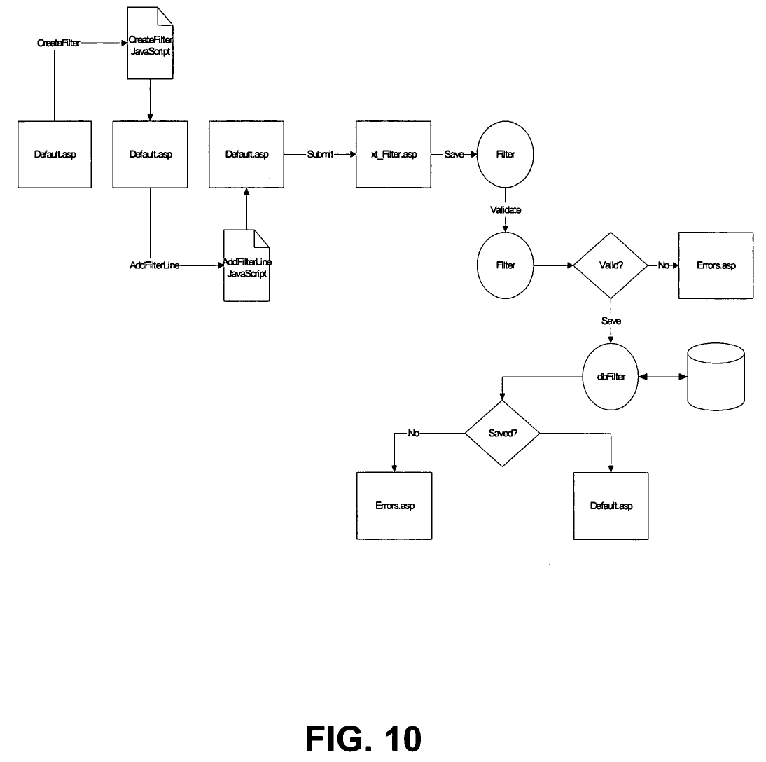

FIG. 10 is a block diagram illustrating a preferred data flow when a user creates a new filter, such as, but not limited to, when a user clicks on the “filter” menu and selects the “create filter” menu item. Filter Page is opened with an empty filter definition. User builds the filter by selecting columns

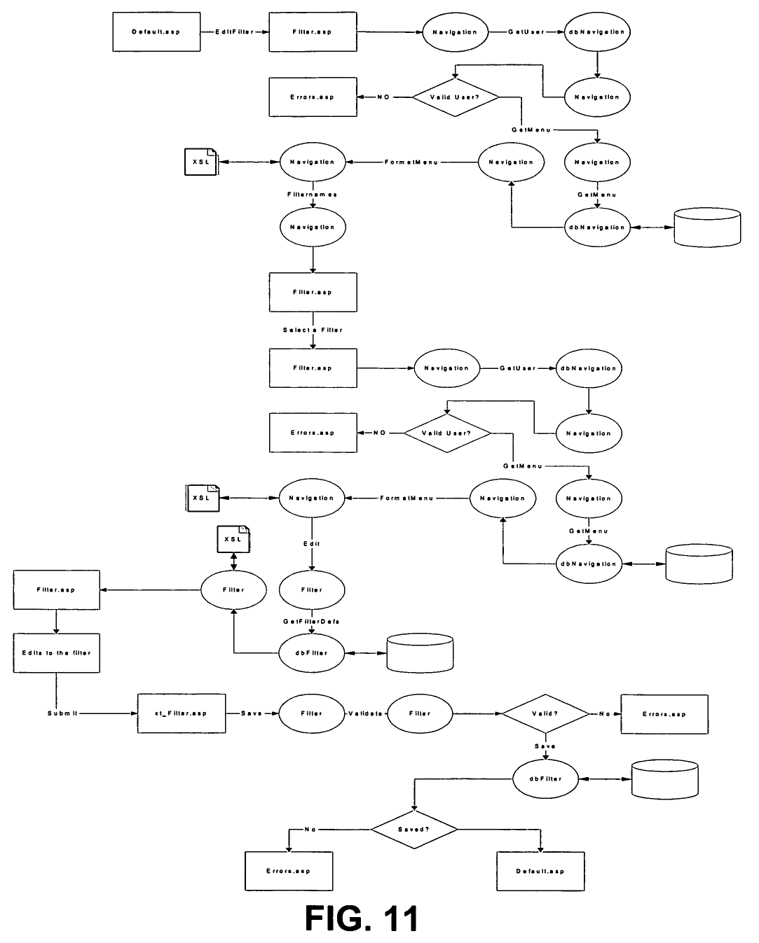

FIG. 11 is a block diagram illustrating a preferred data flow when a user edits an existing filter. The user clicks on the “filter” menu and selects the “edit filter” menu item. A page is opened with the list of existing filters. The user selects the filter to edit and can modify the existing queries by deleting or modifying field values. New fields can be added by specifying fields that are available from the system dictionary.

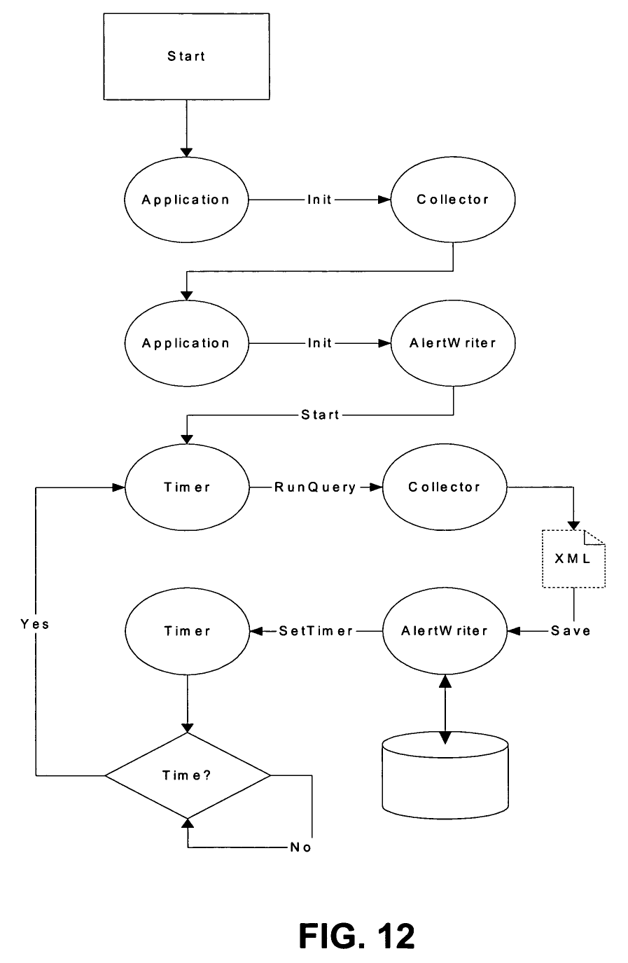

FIG. 12 is a block diagram illustrating a preferred collector data flow. Collector object is a highly configurable object that can connect to any OLDEB/ODBC/JDBC source, perform an SQL query and save the results in a file an XML format defined in the configuration parameters.

The Collector object's ‘Init’ method sets the connection parameter for the source, creates a record set using the SQL statement specified in the configuration file, maps the record set's columns to XML elements. The ‘RunQuery’ method opens the record set and saves the data into an XML file. ‘RunQuery’ accepts an argument that specifies the time and date. If the argument is not null, query selects the records with ‘StateChange’ greater and equal to the value passed as the argument.

FIG. 12—Object Definitions are provided in the following sections
User Interface

Major components of the user interface are main page, which contains a menu and a view grid, popup window to display alarm details, and several popup windows to mange views, filters, users, groups, dictionary fields, etc.
Main Page
   Main page should display a menu for navigation and a “grid” to display alarms.
   The alarm “grid” should contain navigation controls to allow users to move back and forward the filter results.
   Users should be able to select any view from their menu and view it on their browser.
   Users should be able to apply any filter from their menu to any view.
   Users should be able to click on any column header and sort the view by that column (descending). Consecutive clicks on the same column should change the sort direction (descending to ascending or ascending to descending).
   Browser should “refresh” its data every 60 seconds (this can be a system level configurable parameter). When the browser refreshes, the current position in the record set, current view and filter information and the current sort order (and its direction) should not change.
   Users should be able to get detailed information about an alarm.
   Menu should reflect system wide menu items and user specific user items, such as view names and filter names.
   Users who do not have privileges to some functions because of their roles should not be able to access the menus or menu items that invoke those functions (system admin functions, publisher functions, user/group management functions, etc)
   Menu should maintain its cross-browser functionality.
Alarm Detail
   Alarm detail window should display all available fields of an alarm.
Popup Windows
   These popup windows do not need to have a menu bar.
   Consistency on the look and feel should be kept all across the popup windows and should be easily changed from one source.
   Based on the user's role, some of these popup windows should display extended or limited data or functionality (such as list of users will be different between an administrator or group manager or managers may be able to add users to a group but will not be able to edit other parameters where an administrator will be able to perform all functions.)
   After all validations, errors should be displayed with an option to go back and make modifications.
View
Views include a group of fields (columns) saved under a specific name. A view, in conjunction with a filter (described below), makes up an alarm “grid”.
Create/Edit/Delete
   Users should be able to specify any number of fields that are available from the system dictionary to be able to create or modify a view.
   Users should be able to specify the order of the fields while creating or modifying a view.
   Users should be able to specify width and wrap parameters for each field in the view.
   Users should be able to specify how the data should be sorted for the view.

Fields to sort the data will be based on the fields that the user has chosen to display. User also will be able to choose multiple fields and different directions (ascending or descending) for sorting.
Users will be able to create, edit or delete views.
Each user will have to have one “default” view. Default view cannot be deleted. Default view can be modified or another view can be set as a “default view”.
Each view must also have a default filter.
All View names should be unique for a given user. View names should allow the following characters in the filter name (', $, #, &, *, %).
Users will be able to specify how many rows to retrieve to display a view.
While displaying the alarm “grid”, only the user-friendly column display names should be placed on the column header of the “grid”.
Filter

Filters in, in a preferred embodiment, can be described as a “query” saved under a specific name.

1.1.1 Create/Edit/Delete
All users should be able to create, edit or delete filters.
Users should be able to create simple or complex queries by specifying fields that are available from the system dictionary, operators (such as equal, greater then, less then, etc.), user specified values, left/right parenthesis and “and” “or” key words to group multiple criterion to together.
Users should be able to specify any number of fields that are available from the system dictionary to be able to create or modify a filter.
For each user, the default filter of the user's default view cannot be deleted.

However, the default filter can be modified or another filter can be set as a default filter.
All filter names should be unique for a given user. Filter names should allow the following characters in the filter name (', $, #, &, *, %).
Filters can become invalid if the dictionary fields are deleted or field data types are changed. The status of these effected filters will be set to “invalid” by the dictionary object. Filter object should not allow these filters to be applied to views before the users correct them.
All filters should work with any view.
Assign
   Administrators and Managers can assign the filters that they create to other users.
   Assign action will copy this filter to the user's filter list and rename the filter name if the user already have a filter with the same name.
Publisher & Alarm Management
Authorized Users
   A system administrator will give “Publish” access to appropriate external sources for each user. These will be the “authorized” users for publishing.
   Administrator can also remove the “Publish” privilege from a user.
   When a ‘Publish’ access to external sources is granted by the administrator, the system will ask for a valid user name and password for those sources when that user makes an attempt to perform alarm management functions. The external system's username and passwords will be used to verify and validate the user against that external source and collect additional information such as the user id and the group id.
   Once the additional user information (user id and group id) is collected, the user's password for that external system will not be saved or stored in the database. The system will perform all the updates and deletes for that user through the system level account and will pass the correct user id and group id for the update functions.
   Users who have ‘Publish’ privileges and who has already completed their account initialization will be able to “Synchronize” their account info. This function primarily checks and validates user's group information and existence of the user id in the external system.
Connectivity
   Updates via Database Connectivity (ODBC/JDBC) will be the primary method of sending update and delete messages to external sources. API (if available) may be used for the systems that do not provide direct access to their databases or do not store their data in a database.
   The publisher through one account will perform updates and deletes. Therefore, one valid account for that external system (NetCool, NetExpert, HP Open View, etc.) will be needed for connectivity.
   Publisher may make multiple connections using this system level account. However the intent is not to make a connection for each user but to accomplish the ‘Publisher’ process through a pool of connections managed by MTS (Windows) or an application server (Java).
Actions
   Any alarm can be updated or deleted by any “authorized” user if the alarm does not have an owner or it is not assigned to a group.
   If an alarm is assigned to a user (either by the external system or by ‘Take Ownership’ function) only that user or the system administrator of that system can make a modification (update or delete) to that alarm.
   If an alarm is assigned to a group (not the present invention's groups but the external system's groups) and does not have a user associated with it, any “authorized” user that is a member of that group or the system administrator of that system can make a modification (update or delete) to that alarm.
   The ‘Publisher’ functionality for these external systems are:
      NetCool; Acknowledge, De-Acknowledge, Change Severity, Delete, Take Ownership.
      NetExpert; Acknowledge, De-Acknowledge, Delete (Clear).
Collector & Alert Writer
Collector's purpose is to retrieve data from a specified source and populate the database with that data and keeping the two sources in sync.
Collect Data From Source
   Source connection parameters should be configurable
   Destination connection parameters should be configurable
   Source table(s) and column(s) to be extracted should be configurable
   A mechanism should map the source data to a data model, keeping in mind that data model is also user configurable and could change.
   Collectors should be able to handle additions, deletions and updates.
   Collector should provide a mechanism to distinguish different sources data
   Collector should be able to handle different date types (numeric offset date values, database dates, etc.)
   Collector should provide a better error handling and diagnostic “debug mode” information.
   Collector should run like a “service” or a “cron”.
   Frequency of the retrievals should be a configurable parameter.
   Collector should be able to run in any tier (especially either at the middle tier or close to the database tier) independent of the rest of the programs and objects of a preferred embodiment.
   Performance of the Collector should be kept to the maximum.
   Some of the objects that are used to develop the collector could be used to develop a listener “like” application.
   Potential expansion to the Collectors in the future phases could be “callback” like functions (to perform additional lookups and data conversions) for before or after database inserts, updates or deletes.
Configuring the Collector

A collector comprises of two configuration files, Collector.xml and AlertWriter.xml. These files allow administrators to specify properties related to the data source (Collector.xml) and the data storage (AlertWriter.xml).
Explanation of the Collector.xml File

The Collector.xml file comprises a top-level element called <collector> and three child elements <sleeptime>, <connection>, and <table>.
<sleeptime>

This tag has an attribute named time that allows users to specify the frequency of the collection process in milliseconds. If the collector needs to be set to collect alarms from a source every 30 seconds, then the tag needs to be changed to the following;

<sleeptime time=“30000”/>
<connection>

Connection tag and its child tags are used to specify parameters needed for connecting to the data source. The <connection> tag has a child tag named <connectstring> where properties such as driver, server, port, login id and password are specified. The names of these properties can be different from one driver to another.
<table>

This tag allows you to specify the table and schema information where the data is going to be collected. The <table> tag has two properties schema and name. The schema attribute allows you to specify the name of the database schema. The name attribute allows you to specify the name of the table (or view) that the collector will get its data from.
The <table> tag has <timestamp>, <compare>, and <columns> child tags.
<timestamp>

This child tag is used to specify the column on the source table that contains the timestamp for the latest update of the records and its data type. The “datatype” attribute should always be “date” for this tag. The collector will use this column on the source to determine the updated and inserted records for synchronization with the database.
<compare>

This child tag is used to specify the primary key on the source database. The present invention will use this column to perform a comparison with the database to determine the deleted records.
<columns>

This child tag and the accompanying <column> tags are used to specify the columns to obtain from the table that is specified in the <table> tag. The <column> tag allows you to specify the column name and its data type. If you have a new field in your source table and if you also want the Collector to get this new field, simply copy one of the existing <column> tags that match the new field's data type, insert it after the last <column> and before the <columns> tag and edit the name property to the new fields' column name.
Explanation of the AlertWriter.xml File

This file contains <source>, <connection>, and <tables> tags. These tag are primarily used for specifying the data source, destination database connection parameters and the tables and columns involved for saving the records.
<source>

This tag has two attributes, “name” and “id”. The “name” attribute is currently used for information purposes only. However, the “id” tag plays an important role if you are consolidating multiple sources under the database. The number that is assigned to the “id” field will be used to uniquely identify the alarms generated from that source. This field can be any valid number as long as it is unique among the other AlertWriters.
<connection>

The connection tag and its child tags are used to specify parameters needed for connecting to the database. The <connection> tag has a child tag named <connectstring> where properties such as driver, server, port, login id and password are specified. The names of these properties can be different from one driver to another.
<tables>

This tag and its child tags are used to define the storage information. The <tables> tag does not have any attributes, but it contains a child attribute called <table>. There can be more than one <table> tag specified if the data coming from the source needs to be stored in more than one table in the database. However, the application only reads data from the Alert_table.

In most cases, there will be only one table where the external source data will be stored. The field names where the data will be stored and the mapping of the source columns to destination columns will be specified under the <table> child tag.

The <table> tag contains two attributes, “name” and “schema”. The “name” attribute refers to the name of the table and the “schema” refers to the database schema where the table resides.

The first child tag under the <table> tag is called <primarykey>. This tag is used to specify the name of the primary column of the table where the source data is going to be stored and how it is going to be populated. The “column” attribute denotes the primary key field and the “source” attribute denotes the name of the sequence or database function that will be used to provide unique values to the primary key field.

The next child tag is called the <timestamp>. This tag is used for comparing database records to source records based on their date and time in order to determine new and updated records. The attribute “column” represents the date field in the database and the “srccolumn” represents the field that contains the latest update to the source record.

Because the present invention synchronizes the source database and the system's database in a non-intrusive way, it has to compare records to be able to determine the deleted ones from the source. The <compare> tag is used for this purpose. The “column” attribute specifies which column in a database table will be compared to the source. The name of the column on the source database is specified through the “srccolumn” attribute.

The next three child tags are used to specify the database columns and their source columns for insert, update, and delete actions. Through the use of <timestamp> and <compare> tags, the collector determines which records are new, which records are modified and which records are deleted. Once the action type is determined, the collector uses the field names and the source columns specified under the <insert>, <update>, and <delete> tags to perform the action.

The <insert> and <update> child tags are very similar in configuration. Both tags have <columns> tag as a child tag and several <column> tags under the <columns> tag. The <column> tag has “name”, “srccolumn”, “type” and “size” attributes. The “name” attribute represents the column name in the database, the “srccolumn” represents the name of the source column, and the “type” attribute represents the data type of the I database column specified in the “name” attribute. The type values can be “varchar” for text, “number” for numeric and “date” for date and time. The “size” attribute is only needed for the text fields. It is used to specify the length of the database field that holds the text value.

There are two child tags under the <update> tag. The first tag is the <columns> tag as mentioned previously. The second tag is the <key> tag that is used for identifying which record is going to be updated. The collector will use the column name (or names) specified under the <key> tag along with the source id to locate a record for updating.

The same <key> tag is also used under the <delete> tag as well. The collector uses the column specified under this tag and the source id to delete records from the database that are already deleted from the source database.
Tools

A Tools interface allows the system to extend its data to other systems, programs, and scripts without additional programming changes to the present invention. This is accomplished by transferring data to these external applications via the HTTP protocol.
Create/Edit/Delete Tools
   Only Administrators can create tools
   Tool builder allows the authorized user to specify the HTTP method, destination URL, name of the tool which will appear under the tool menu, fields to pass to the external application and translation of these field names to other names desired by that external application.
   Tools should be able to send its data via value pairs or XML.
Security

Security, in a preferred embodiment of the present invention comprises two major parts, “authentication” and “authorization”.
Authentication
   There should be no limit to the number of “named” users who can log in and use features of the present invention (“named” users is different than the number of concurrent users which is related to the system resources).
   All users should be authenticated by the system of the present invention.

Authentication will be done by the security module (objects) through one of the following ways:
internal account management (both for UNIX and Windows)
LDAP interface (both for UNIX and Windows)
NT Local or Domain Accounts (only for Windows)
Mechanism to encrypt passwords needs to be developed or purchased. One-way hash is a possible implementation for encrypting passwords.
Security solution should work in any type of load balancing.
Resources required to implement “authentication” should be kept to the minimum as possible while keeping the performance to the maximum.
Authorization
   Authenticated users will fall into one of the “roles”:
      Administrators
      Managers
      Users
      Read Only Users
   Authorization to pages will be “role” based. For performance reasons, system will maintain a list of “restricted resources” for each group.
   Role is a required argument for creating users and default should be set to “Users”
   Resources required to implement “authorization” should be kept to the minimum as possible while keeping the performance to the maximum.
User Management
Create/Edit/Delete User
   Each user of the present invention must have a valid user name and password
   Each “valid” user must belong to a “group”. The present invention will have a system level default group.
   Each user must belong to a “role” (admin, manager, user, read-only).
      Administrators can create, modify or delete groups and users. They also can view data (create, modify, delete views and filters) and perform “alarm management”.
      Managers can create, edit or delete users only within their group.
      They cannot modify other group parameters. Managers can also view data (create, modify, delete views and filters) and perform “alarm management” functions. Managers can “assign” filters to other users.
      Users can only view data (create, modify, delete views and filters) and perform “alarm management” functions.
      Read-Only Users can only view data (create, modify, delete views and filters) and but cannot perform “alarm management” functions.
   Users can change their passwords. Password is a required parameter!
   Each user will have a default view and a filter.
   Each user may have a “restriction” assigned by their manager. Restriction acts as an additional condition on a where clause of a filter owned by that user.
Group Management
Create/Edit/Delete Group
   Each group will have a manager.
   Groups will have names.
   The number of users that can be associated with that group can be limited to certain number via the “Maximum Number of Users” parameter.
   Each group may have a “restriction” assigned by the administrator who created that group. For the members of the group, this restriction will act as an additional condition on a where clause of a filter owned by a user.

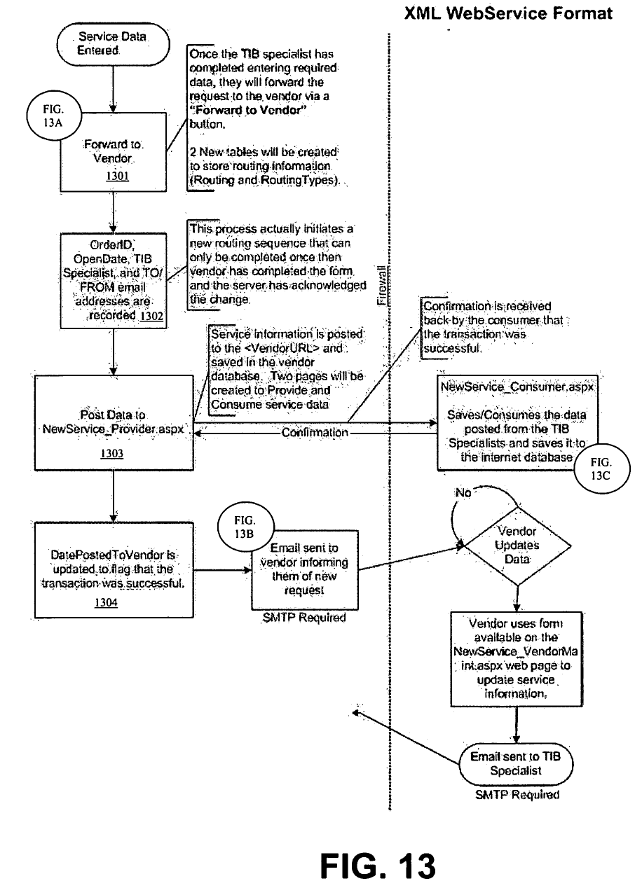

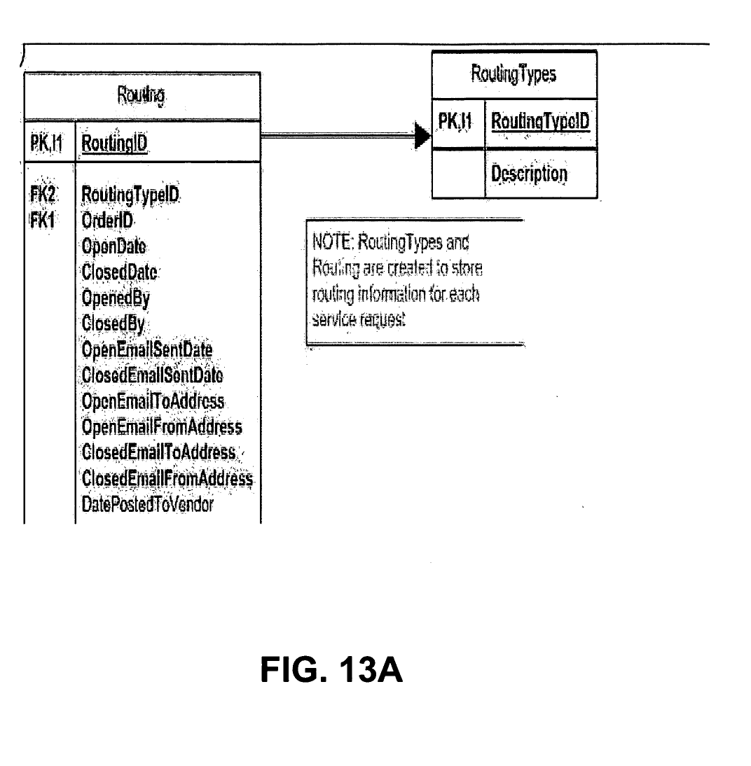

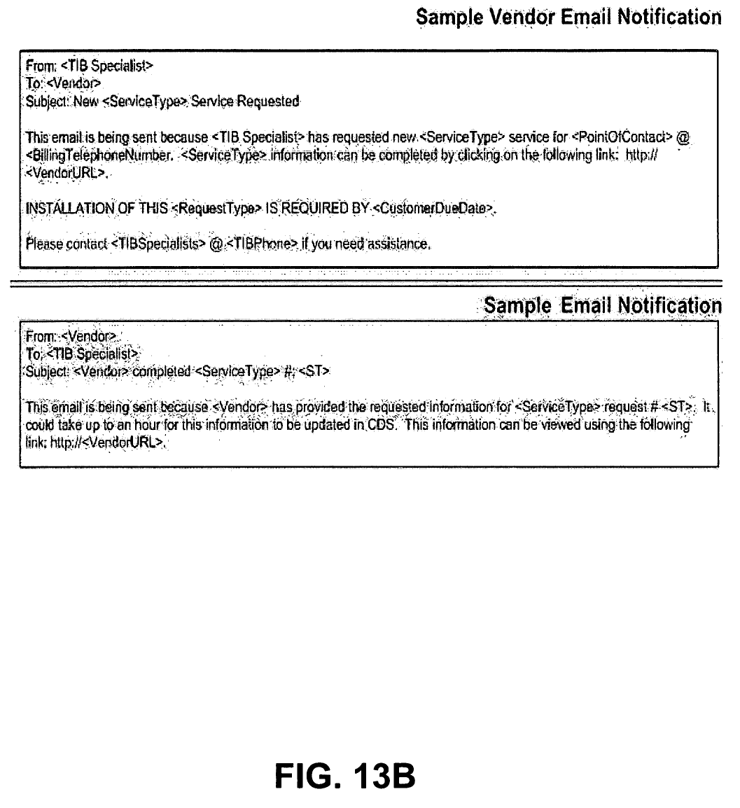

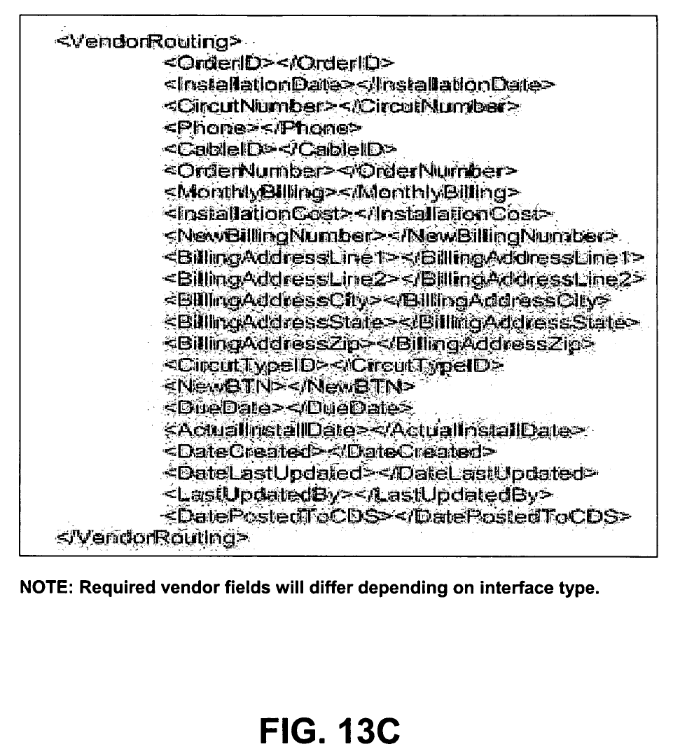

FIG. 13 illustrates an example of an implementation of the first embodiment. At step 1301 when required data for a service request has been entered into a form, the form is forwarded to the vendor. Two new tables are created to store routing information (Routing and RoutingTypes), see FIG. 13A. At step 1302 a process initiates a new routing sequence than can only be completed once the vendor has completed the form and the server has acknowledged the changes made by the vendor to the form. At step 1303 service information is posted to the <VendorURL> and saved in the vendor database. Two pages are created to Provide and Consume service data and the vendor uses these forms on the New Service_VendorMaint.aspx web page to update service information. At step 1304 the DatePostedToVendor is updated to flag that the transaction was successful and an e-mail is sent to the vendor informing the vendor of a new service request, see FIG. 13B. e-mail is sent by the vendor to the requestor (TIB specialist in FIGS. 13, 13B). FIG. 13C is a typical XML WebService format for vendor information.

Given the publishers and collector can interface to any type of external as well as internal system, the overall architecture of the present invention allows for inclusion of systems based on evolving/new products and technologies. The architecture permits for the interface to be anything from HTML to Wireless Applications.

The architecture of the present invention is directed to an open system that is distinguishable from the Client-Server solutions of proprietary prior-art systems in which not only is a server component of required, but individual client installations are required for gateways/probes/APIs to other systems they have interface or integrate with.

In all preferred embodiments, only a server component is required that does not involve any client software, since the architecture of all preferred embodiments is open and XML-based. For example, in an implementation of the present invention where the universal user interface uses a browser, any number of users can pull data and present it in various mediums and technologies without browser plug-ins, which represents a considerable savings in cost and complexity and contributes to the deployability and robustness of implementations of the current invention.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention as well.

I claim:

1. A system for unified service order and provisioning management, comprising:
a service order database for persistent storage of service orders, responses to service orders, and data related to provisioning of service order support by at least one service provider; and
a configurable service order processing component arranged to
to receive at least one service order in XML format from a requester and store the received at least one service order as at least one originating service order in the database,
to retrieve the stored at least one originating service order from the database and send the retrieved at least one originating service order in XML format to at least one service provider,
to receive at least one response from at the least one service provider, said at least one response being in XML format, that corresponds to the at least one originating service order and store the received at least one response in association with the at least one originating service order.

2. The system of claim 1, wherein:
the database further comprises stored information concerning the at least one service provider including services available and provisioning contract information, and default database views and filters, and user-specific database views and filters, and the system further comprises a provisioning contract monitoring component that tracks:
expiration of the provisioning contract of the at least one service provider,
use of the provisioning contract of the at least one service provider by a requester,
quality and timeliness of services provided under the provisioning contract to the requester of the at least one service provider.

3. The system of claim 2, further configured to accept input and provide output to a configurable universal web-based interface for:
the requester to create, store in the database, and track a service order, and
the provider to retrieve the service order from the database, respond to the service order and store the response to the service order in the database, wherein said interface provides networked access to the system from anywhere and at any time, said interface being based in part on the views and filters stored in the database.

4. The system of claim 3, wherein the database is a relational database.

5. The system of claim 3, wherein the web-based interface is based on a web browser and the networked access is Internet access.

6. The system of claim 3, wherein the web-based interface is outside a firewall of a requester.

7. The system of claim 6, wherein the web-based interface is based on a web browser and the networked access is Internet access.

8. The system of claim 7, wherein the database is a relational database.

9. The system of claim 8, wherein the relational database is selected from the group consisting of Oracle and SQL Server.

10. A universal help-desk system, comprising:
a help request database for persistent storage of help requests and responses thereto for a plurality of trouble ticketing systems; and
a configurable help request processing component arranged to
to collect, from a plurality of trouble ticketing sources, help requests and responses thereto in XML format and store the collected help requests and responses in the database,
for each trouble ticketing source, to retrieve the stored help requests and responses from the database and publish the retrieved help requests and responses in XML format to the other trouble ticketing sources,
to send each collected help request to an appropriate one of the trouble ticketing systems for resolution and correlate any response received with the sent help request.

11. The system of claim 10, further comprising a correlation, trend analysis and probable-cause analysis component that analyzes the collected help requests and responses.

12. The system of claim 11, wherein the database is a relational database.

13. The system of claim 12, wherein the relational database is selected from the group consisting of Oracle and SQL Server.

14. The system of claim 13, further configured to accept input and provide output to a configurable universal web-based interface for a requester to create, store in the database, and track a help request, said interface providing networked access to the system from anywhere and at any time, said interface being based in part on default database views and filters and user-specific database views and filters stored in the database.

15. The system of claim 14, wherein the web-based interface is based on a web browser and the networked access is Internet access.

16. A system for unified real-time event data collection and reporting, comprising:
an event database for persistent storage of monitored events;
a configurable data collection engine arranged to collect, from a plurality of message sources comprising a plurality of event monitoring systems, event occurrence data in XML format, identify the collected event occurrence data by source and store the collected and identified event occurrence data in the event database;
a publication component to
for each message source, in response to an input query including selection criteria therefor, retrieve the stored event occurrence data for the source in XML format and publish the retrieved event occurrence data as output in XML format to the message source, and
for all event monitoring sources, in response to an input query including selection criteria therefor, retrieve the stored event occurrence data and display the retrieved event occurrence data as output in a consolidated view.

17. The system of claim 16, wherein:
the database further comprises stored information concerning trends and correlations between events reported by different sources of the plurality; and
the publication component further comprises
i. a query engine component to
process the query and retrieve the data base events that match the query, and
apply view and filters to the retrieved data base events to form a query output, and
ii. a display engine to
authenticate and authorize a database access request as an accepted query,
forward the accepted query to be processed by the query engine,
display the query output produced by the query engine.

18. The system of claim 17, wherein the event monitoring systems include a plurality of system types selected from the group consisting of performance management, fault management, security management and provisioning management.

19. The system of claim 17, further configured to accept input from and provide output to a configurable universal web-based interface for a searcher to create and submit an input query to be executed against the event database and receive a suitably formatted query output, wherein said interface provides networked access to the system from anywhere and at any time.

20. The system of claim 19, wherein the web-based interface is based on a web browser and the networked access is Internet access.
